(19) United States
(12) Patent Application Publication
(10) Pub. No.: US 2002/0175528 A1
(43) Pub. Date: Nov. 28, 2002

(54) Fence-pulling device and method for attaching non-rigid fencing to fence-posts

(76) Inventor: Spence L. Stewart, Scappoose, OR (US)

Correspondence Address: BIRDWELL, JANKE & DURANDO, PLC, Suite 1400, 1100 SW Sixth Avenue, Portland, OR, 97204, US

(21) Appl. No.: 10/040,874

(22) Filed: Jan. 4, 2002

Related U.S. Application Data
(62) Division of application No. 08/991,332, filed on Dec. 16, 1997, now abandoned.

(51) Int. Cl. B66C 1/42

(52) U.S. Cl. 294/132

(57) ABSTRACT

A fence-pulling device and method for attaching non-rigid fencing material to fence-posts. One end of a sliding chain is connected to a fence-pulling engine such as a tractor, while the other end of the sliding chain is hookably attached to a slide bar adapted to permit the sliding chain to slide along portions thereof in response to components of the pulling force which are aligned with the slide bar, such as would result, for example, where fencing material is applied to fence-posts set in non-level ground.

This is a divisional of Ser. No. 08/991,332, filed Dec. 16, 1997, now pending.

### BACKGROUND OF THE INVENTION

This invention relates to a fence-pulling device and method for attaching relatively non-rigid fencing material to fence-posts, particularly fence-posts that have been previously set into the ground.

Non-rigid fencing material, such as woven or fabric steel fencing, must be pulled tightly across set-in fence-posts to which the material is to be attached, to prevent looseness and sagging that would be unsightly and detract from the structural integrity of the fence. A particular consideration is to pull top and bottom edges of the fencing material with substantially the same degree of tensile force, so that stress carried by the fabric of the fence is equally distributed thereacross. The problem is complicated by the need to apply the fencing material so that it substantially follows the contour of the ground over which it is being installed.

A particularly advantageous prior art fence clamp for pulling such fencing material is manufactured and marketed by Stewart Fence Co., LLC of Scappoose, Oreg., as the STEWART FENCE CLAMP STRETCHER (hereinafter the “Stewart” fence clamp). The Stewart fence clamp gains purchase on the fencing material across substantially the entire width of a free end thereof The puller includes attachments proximate top and bottom corners of the free end for hooking respective lengths of upper and lower chain which are, in turn, hooked together at a pull-point carried by a pulling engine or device such as a tractor or come-along. Such chain connections between a fence-pulling device and a tractor are exemplified in, e.g., Combs, Jr., U.S. Pat. No. 3,881,690 and Handley, U.S. Pat. No. 3,211,426. Where the fencing material is to be attached to fence-posts set in level ground, and where the elevation of the pull-point is appropriately selected to lie midway between the respective points of attachment of the two chains, achievement of the aforementioned objective is naturally compelled by simple principles of geometry.

However, typically, the fencing material is to be attached to a course of vertical fence-posts that are set in ground that changes elevation. The fencing is stretched over such a number of the fence-posts that a taut length of fencing material will be above the ground level of the fence-posts that lie between a first and last fence-post. The fencing material is then manually pulled downwardly, at each fence-post, to register the fencing material with the fence-post for attachment thereto. Generally, however, the fencing material lies on a line making an angle with respect to the fence-posts, and the simplified geometry of the above described configuration is lost. Particularly, when the fencing material is pulled at an angle, one of the aforementioned chains will generally carry an increased tensile force while the other chain will tend to slacken.

The ordinary method employed in response to this problem includes installing a temporary anchoring brace beyond the last fence-post, attaching the fencing material to the anchoring brace while the tractor continues to carry the load of the partially taut fence, positioning the tractor to shift the load to the anchoring brace and thereby relieving the tension on the upper and lower chains, effectively shortening the slackened chain by hooking the chain to the pull-point through a different link of the chain, re-positioning the tractor to shift the load back thereto, releasing the fence from the temporary anchoring brace, and proceeding to pull the fencing material increasingly taut. A number of iterations of this time-consuming procedure may be required.

Accordingly, there is a need for a fence-pulling device and method for attaching non-rigid fencing material to pre-positioned fence-posts that automatically continues to provide for pulling top and bottom edges of the fencing material with substantially the same degree of tensile force when changes in the angle that the fencing material makes with respect to the fence-posts are encountered, such as that resulting from changes in ground elevation.

### SUMMARY OF THE INVENTION

The present invention solves the aforementioned problems and meets the aforementioned needs in a fence-pulling device and method for attaching non-rigid fencing material to pre-positioned fence-posts by providing a slide bar and cooperating sliding chain. The slide bar extends transversely with respect to the length of the fencing material and is adapted to slidingly receive, in transverse translation along a portion thereof, a sliding end of the chain. The other end of the chain is fixedly connected to a pull-point of a pulling device. When pulling the fencing material, the sliding end of the chain slides along the slide bar in response to a component of the pulling force that is aligned with the slide bar, the sliding end of the chain finding a position along the slide bar that adjusts the tension applied by the fence-pulling device so as to pull top and bottom outer edges of the fencing material with substantially equal tensile force.

Accordingly, it is a principal object of the present invention to provide a novel fence-pulling device and method for attaching non-rigid fencing material to pre-positioned fence-posts.

It is another object of the present invention to provide such a method and apparatus that provides for automatically continuing to pull top and bottom edges of the fencing material with substantially the same degree of tensile force when changes in the angle that the fencing material makes with respect to the fence-posts are encountered.

The foregoing and other objects, features and advantages of the invention will be more readily understood upon consideration of the following detailed description of the invention, taken in conjunction with the following drawings.

### BRIEF DESCRIPTION OF THE DRAWINGS

FIG. 1 is a side elevation of a fence-pulling device and method showing a context for the present invention.

FIG. 2 is a pictorial view of a prior art fence clamp for use with the fence-pulling device and method of the present invention.

FIG. 3 is a side elevation of a particularly advantageous prior art fence-pulling device.

FIG. 4 is a force-diagram showing the forces resulting from pulling fencing material across the fence-posts of FIG. 1 with the device of FIG. 3.

FIG. 5 is a side elevation of a fence-pulling device according to the present invention.

FIG. 6 is a force-diagram showing the forces resulting from pulling fencing material across the fence-posts of FIG. 1 with the device of FIG. 5.

### DETAILED DESCRIPTION OF A PREFERRED EMBODIMENT

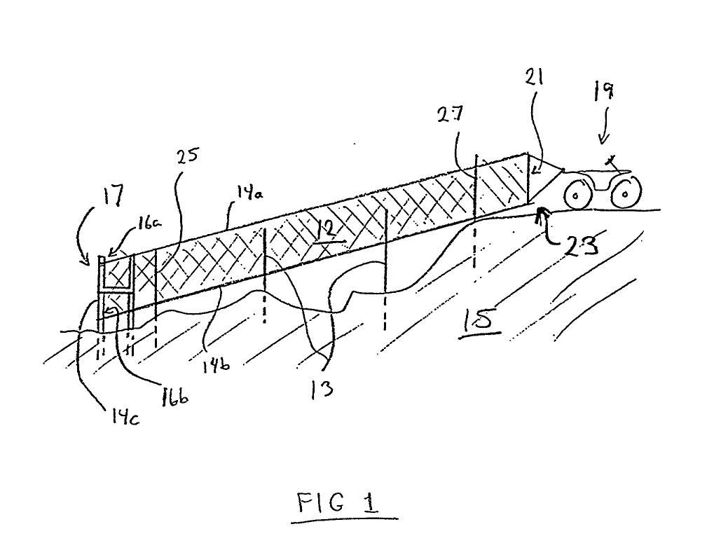

FIG. 1 depicts the context in which the present invention is generally employed, for attaching non-rigid fencing material 12 to fence-posts 13 set in ground 15. The material 12 is typically woven or fabric steel fencing, but may be formed of other materials, including plastic. While the invention provides a solution to problems unique to attaching non-rigid fencing material, it may be employed for attaching other types of fencing material without departing from the principles thereof

The fencing material 12 is typically provided in rolls of relatively long, continuous lengths. When laid out, the fencing material generally has a rectangular form defined by top and bottom outer edges 14a, 14b and a side edge 14c that is immediately presented to the user at the outer circumference of the roll. The top and bottom outer edges of the fencing material terminate in the side edge at respective first and second corners, 16a and 16b.

Generally, the fencing material is to be attached to a course of the fence-posts 13 that are set in ground that changes elevation. To illustrate, the fence-posts are typically spaced about 12 feet apart, are plumbed to project substantially vertically from the ground, and the fencing material is laid out over a length of about 300 to 1000 feet before attachment thereto. To prepare the fencing material 12 for attachment, a sturdy anchoring brace 17 is provided, typically having an “H” configuration, and is firmly set into the ground 15 adjacent a first of the fence-posts 25. The side edge of the fencing material is attached to the anchoring brace at the corners 16a and 16b of the fencing material. The roll of fencing material is unwound, e.g., as it is being carried on a pulling engine such as a tractor 19 or otherwise extended, such a distance so that a taut length of the material will be above the ground level of the fence-posts that lie between a the first fence-post and a last fence-post 27. The material is then cut width-wise to form a free end 21, and the free end is attached to the tractor through a pulling device 23. As has been previously discussed, the fencing material is then manually pulled downwardly, at each fence-post, to align the fencing material with the fence-post for attachment thereto.

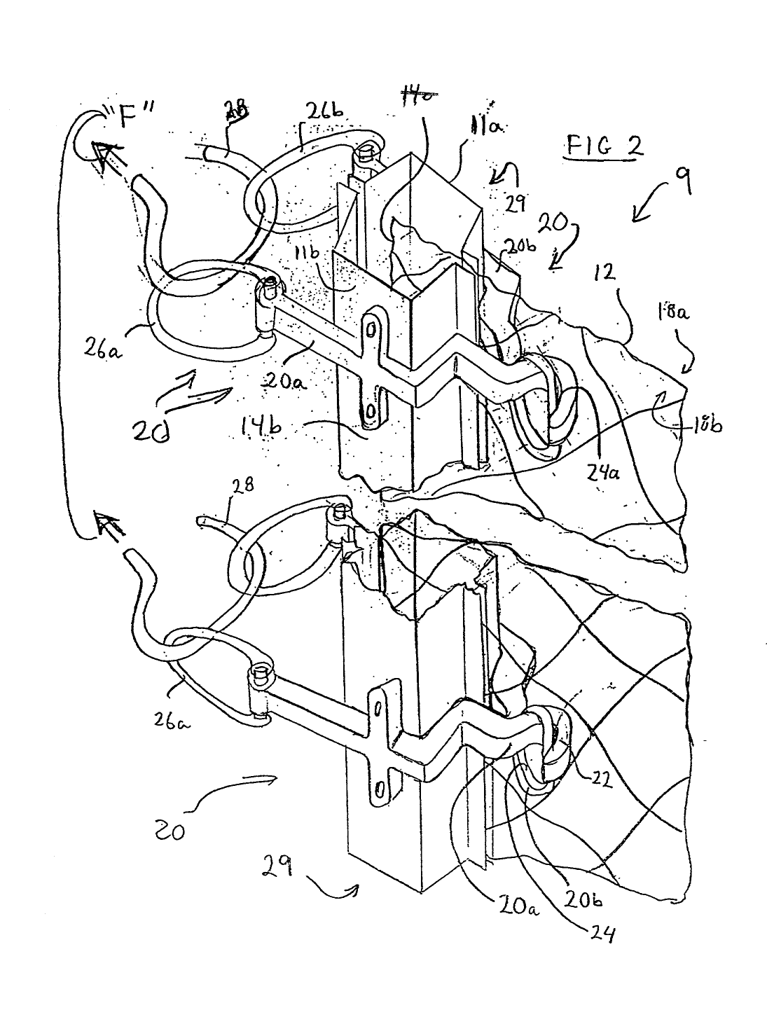

Referring now to FIG. 2, the aforementioned prior art Stewart fence clamp is depicted. The below described fence-pulling device of the present invention preferably employs this fence clamp, attached to the free end 21 of the fencing material. The Stewart fence clamp 9 includes a first elongate gripping portion 11a and a substantially symmetrical second elongate gripping portion 11b adapted for gripping the fencing material 12 in anticipation of pulling the fencing material. Elongate axes of the gripping portions are generally aligned with the side edge 14c and are preferably long enough to span and thereby grip the entire width of the fencing material.

The gripping portions are separable for positioning on respective sides 18a, 18b of the fencing material 12. The gripping portions are adapted to attach together by use of clasps 20. Further, the clasps are adapted to receive a pulling force “F” and to couple the force to the gripping portions so as to cause the gripping portions to exert a force toward one another in response thereto, to tightly capture the fencing material therebetween.

Two clasps are employed along the gripping portions. Preferably, the clasps are positioned along the gripping portions in consideration of optimizing the distribution of pulling stress across the fencing material. Typically, for this purpose, the clasps are placed inwardly from each end 29 of the gripping members a distance that equals about a quarter of the length of the gripping members.

The clasps each include a male portion 20a and a female portion 20b. The male portions of the clasps are rigidly attached to one of the gripping portions while the female portions of the clasps are rigidly attached to the other gripping portion. The male portions of the clasps each include a hook 22 for hooking into corresponding apertures 24 in the female portions. The hooks and apertures are formed so that insertion of the hooks into the apertures is initially facilitated by a generous clearance; however, as the gripping portions are brought down against the fencing material each hook sets tight against a locking surface 24a of the corresponding aperture 24.

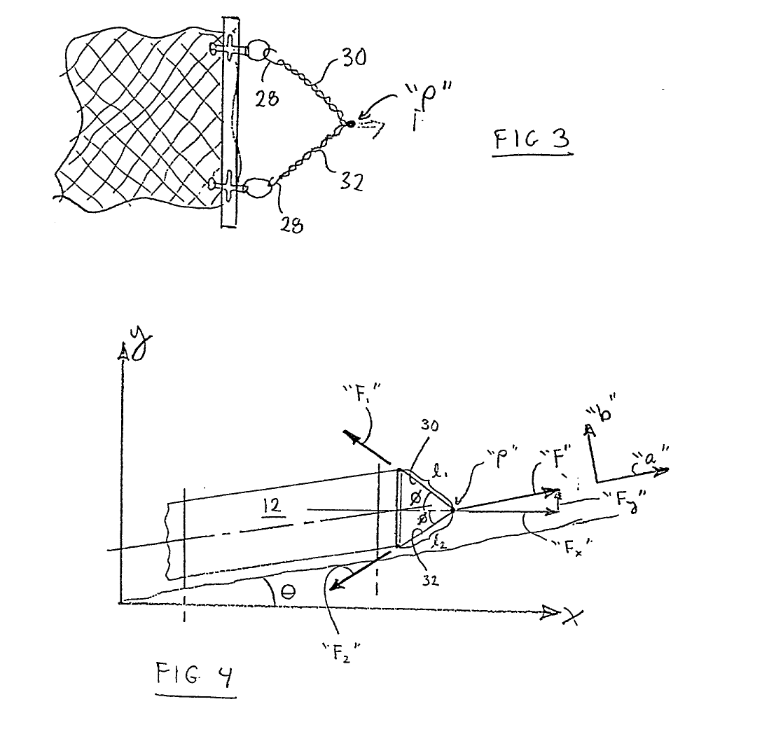

The portions 20a, 20b of each of the clasps 20 are further provided associated eyes 26a, 26b adapted for receiving associated hooks 28. Referring to the prior art fence-pulling device as it is depicted in FIG. 3, one of the hooks 28 is attached to an upper chain 30 and the other of the hooks 28 is attached to a lower chain 32, the upper and lower chains in turn being connected at their free ends to a pull-point “P” of a pulling engine such as the tractor 19 of FIG. 1.

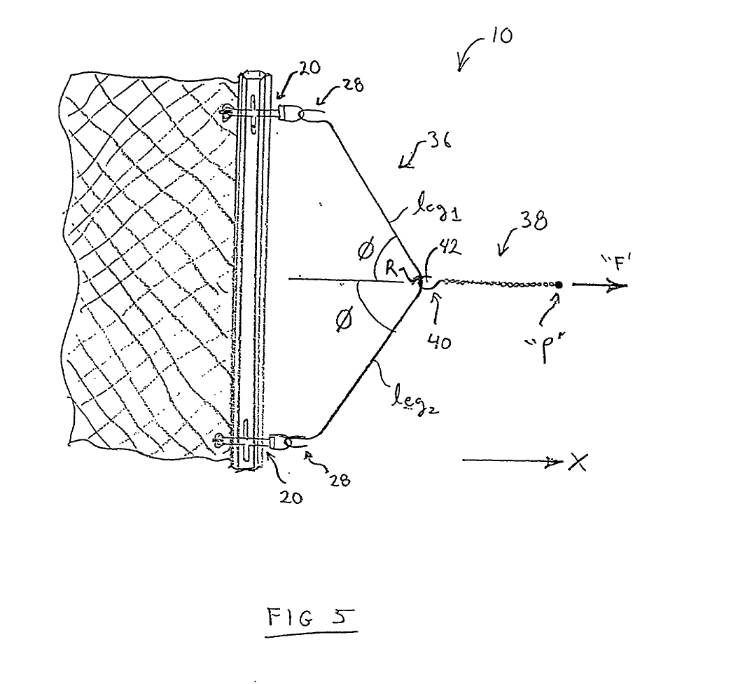

Referring now to FIG. 4, an illustrative example of a force-diagram for the prior art pulling device is provided. In the example, the fencing material 12 is being pulled up an inclined surface, having an angle of incline Θ with respect to an x-y coordinate system. The pulling force “F” is applied to a length l₁ of the upper chain 30 and a substantially equal length l₂ of the lower chain 32 through the pulling-point “P” and resolves into a force component F₁ lying along the length 1₁ and a force component F₂ lying along the length l₂. For purposes of illustration, the upper and lower chains are both shown under some tension and, because they are of substantially equal length, make substantially equal angles Φ with respect to the “x” axis.

“F” lies along a direction “a” that lies at the angle Θ with respect to the “x” axis and resolves into a force component Fₓ in the “x” direction and a force component F_{y} in the “y” direction. The force component Fₓ pulls the fence forward and tends to pull each of the chains equally. However, the force component F_{y} tends to pull the lower chain 32 tighter and to decrease the tightness of the upper chain 30. More particularly, summing forces in the “a” direction provides that

F=F₁(cos (Φ+Θ))+F₂(cos (Φ−Θ)),

and summing forces in a “b” direction which is perpendicular to the “a” direction provides that

F₁(sin (Φ+Θ))=F₂(sin (Φ−Θ)).

As an example, it can be seen that when Φ=Θ=45 degrees, F₁=0 and F₂=F, signifying that tension in the upper chain has fallen to zero and the lower chain is carrying the entire pulling force “F”.

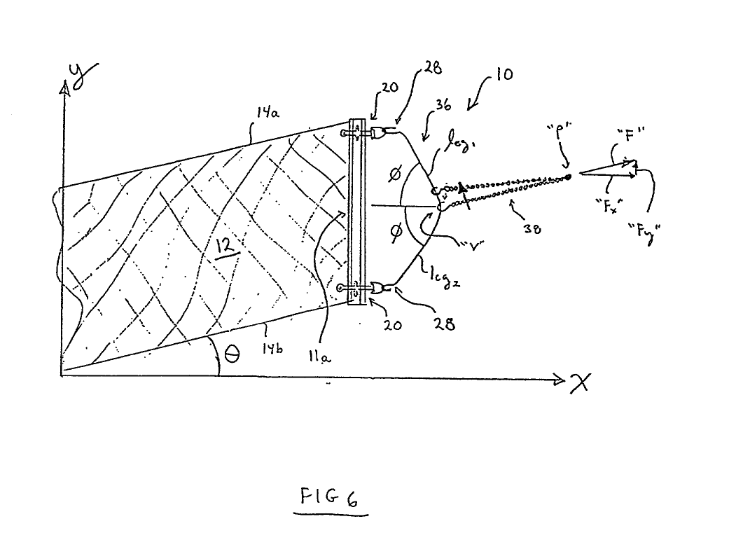

Turning now to FIG. 5, a fence-pulling device 10 according to the present invention provides a slide bar 36 and sliding chain 38 for transmitting the pulling force “F” from the pull-point “P” to the clasps 20. The slide bar is of elongate form and includes the hooks 28 at polar ends thereof. The sliding chain 38 is also of elongate form and includes a hook 40 for hooking around the slide-bar at one polar end thereof. At the other end thereof, the sliding chain is attached to the pull-point “P”.

The hook 40 and slide bar 36 are adapted so that the hook is permitted to slide along the slide bar in response to any component of the pulling force “F” that is parallel thereto. The slide bar is formed in a modified “V” configuration, wherein the vertex of the “V” is radiused to facilitate sliding of the hook from one leg “leg₁” of the “V”, on one side of the vertex, to the other leg “leg₂” of the “V”, on the other side of the vertex. The slide bar preferably has a circular cross-section and the hook has a circular hooking aperture 42 having a larger diameter than the diameter of the cross-section of the slide bar, to facilitate sliding of the hook on the surface of the slide bar. Leg₁ and leg₂ of the slide bar 36 each form an angle Φ with respect to the “x” axis. An angle Φ of about 125 degrees has been found to work well; however, it is believed that the angle may vary considerably and provide the desired function.

Referring particularly to FIG. 6, an illustrative force diagram is provided which, follows the aforementioned example of FIG. 4, here given for the slide bar 36 and sliding chain 38. Again, the fencing material 12 is being pulled up an inclined surface, having an angle of incline Θ with respect to an x-y coordinate system. Extension of the concepts illustrated and discussed herein to other topographic conditions will be apparent to one of ordinary skill in the mechanical arts.

The pulling force “F” is applied to the hook 40 through the pulling-point “P” and the sliding chain 38. “F” has a force component Fₓ in the “x” direction and a force component F_{y} in the “y” direction. The force component Fₓ pulls the fence forward and tends to center the hook at the vertex “v” of the slide-bar. However, the force component F_{y} tends to push the hook upwardly along the leg₁. In general, the hook will move along the slide bar 36 as indicated by the arrow until the force component F_{y} is nearly reduced to zero. When the hook moves this amount, the force “F” pulls equally through the hooks 28 and is everywhere parallel to the top and bottom outer edges of the fencing material 12. Accordingly, the top and bottom outer edges are pulled equally in the direction of “F”.

The slide bar, as are the clasps and, to a lesser extent, the gripping members, subject to a high degree of force and rough treatment, and should be formed of materials having appropriate strength and toughness and should be appropriately sized. The slide bar is preferably formed of ¾″ nominal diameter tool steel rod; however, the slide bar may be formed of other materials having other dimensions and may be flexible without departing from the principles of the present invention.

The fencing material is normally run-out over a substantial distance in comparison to the changes in elevation in the ground surface. Therefore, very small movements of the hook 40 along the slide bar 36 may effect a substantial adjustment in the distribution of tensile forces in the fencing material.

It is to be recognized that, while a fence-pulling device and method for attaching non-rigid fencing material to fence-posts has been shown as preferred, other configurations could be utilized, in addition to configurations already mentioned, without departing from the principles of the invention.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims that follow.

I claim:

1. A fence-pulling device, comprising:
an apparatus adapted for clamping the end of a length of fencing material;
a sliding member; and
a substantially “V” shaped slide bar adapted for hooking attachment to said apparatus, wherein the vertex of said slide bar is radiused sufficiently to facilitate sliding of said sliding member on said slide bar.

2. The fence-pulling device of claim 1, wherein said sliding member is a hook.

3. The fence-pulling device of claim 1, wherein said slide bar is formed of steel.

4. The fence-pulling device of claim 3, wherein said slide bar has a circular cross-section.

5. The fence-pulling device of claim 4, wherein said slide bar has a nominal ¾″ diameter.
